(19) United States
(12) Patent Application Publication
(10) Pub. No.: US 2024/0210517 A1
(43) Pub. Date: Jun. 27, 2024

(54) Concreting System with Position Detection for Concrete Vibrator

(71) Applicant: Wacker Neuson Produktion GmbH & Co. KG, Reichertshofen (DE)

(72) Inventors: Christian Lange, Ingolstad (DE); Rudolf Berger, Gruenwald (DE); Patrick Diller, Hohenwart (DE); Alto Weiskopf, Altomuenster (DE)

(21) Appl. No.: 18/390,179

(22) Filed: Dec. 20, 2023

(30) Foreign Application Priority Data
Dec. 21, 2022 (DE) 10 2022 134 329.4

(51) Int. Cl. G01S 5/02; E01C 19/40

(52) U.S. Cl. CPC G01S 5/02585; E01C 19/402; E01C 19/407; G01S 5/0247

(57) ABSTRACT

An apparatus is provided for determining the position of a vibration unit for concrete compaction which can be guided by an operator. The apparatus includes a surface position determination device having a receiving device with the surface position determination device being designed to determine the position of the receiving device in the plane. The apparatus additionally includes an orientation determination device for determining an orientation (A) of a working direction of the operator. The apparatus also includes a correction device for correcting the position of the receiving device with an offset (O) in the direction of the orientation (A) of the working direction and, thus. for determining the position (P2) of the vibration unit in the plane.

### BACKGROUND OF THE INVENTION

### 1. Field of the Invention

The invention relates to an apparatus and a method for determining the position of a vibration unit for concrete compaction which can be guided by an operator.

### 2. Description of the Related Art

Freshly poured, still flowable concrete must be compacted in order to release gas inclusions from the concrete and to homogenize gravel nests. This increases the quality and strength of the concrete. A wide range of technical regulations contain corresponding specifications for concrete compaction.

Mobile, i.e. portable, internal vibrators are often used for concrete compaction. Such internal vibrators have a vibration unit for generating a vibration which is introduced into the still flowable concrete in order to compact the concrete. The vibration unit may have, for example, an imbalance exciter and an electric motor driving the imbalance exciter, which are arranged in a common housing, e.g. a vibration bottle. Furthermore, an operating unit, e.g. a switch housing, a frequency converter or the like may be provided as part of the internal vibrator. The vibration unit and the operating unit can be connected to each other by a robust protective and operating hose. The electrical lines for the drive are routed in the vibration unit inside the protective and operating hose. An operator can guide the vibration unit by gripping the protective and operating hose and immerse it into the concrete to be compacted in a targeted manner at the desired locations.

There are also known internal vibrators in which the electric drive is not arranged in the vibration bottle, but outside. In this case, the rotational movement of the electric drive is transmitted to the imbalance exciter in the vibration unit via a flexible shaft. The flexible shaft can also be arranged inside the protective and operating hose.

The electric drive can be supplied on a construction site by electric current from a public network or from a special construction site network. A frequency converter can be used to convert the current obtained via the network into a current suitable for the electric drive in terms of voltage, current type (alternating current) and frequency.

Recently, internal vibrators which obtain their electrical energy via a rechargeable battery (electrical energy store) have also become known. For example, the rechargeable battery can be arranged in a backpack carrying system that can be carried on the back by an operator. In addition to the rechargeable battery, a frequency converter for generating the current required for the electric drive, e.g. three-phase current, can also be arranged in the backpack carrying system. The backpack carrying system allows for high mobility of the internal vibrator without the need for an electrical connection to a network. An example of such a backpack carrying system is described in DE 10 2018 118 552 A1.

In order to comply with technical specifications, it may be necessary to accurately document the concreting process. It may be expedient for the quality or progress of the respective compaction process (degree of compaction) as well as the location of the compaction or the most accurate possible position of the internal vibrator during the compaction process to be recorded for documenting the concrete compaction.

The post-published patent applications DE 10 2022 118 541 A1 and DE 10 2022 118 542 A1 describe concrete compaction apparatuses which are used to measure the respective compaction progress during concrete compaction. However, the respective location of the concrete compaction is not taken into account.

### SUMMARY OF THE INVENTION

The invention is therefore based on the object of determining the location of concrete compaction with the greatest possible and at least sufficient accuracy. This is intended to create the possibility of also recording and documenting the location of the concreting in addition to the quality of the respective compaction process.

The object is achieved according to the invention by an apparatus for determining the position of a vibration unit for concrete compaction which can be guided by an operator. The apparatus includes a surface position determination device having a receiving device, wherein the surface position determination device is designed to determine the position of the receiving device in the plane. The apparatus also has an orientation determination device for determining an orientation of a working direction of the operator. The apparatus still additionally has a having a correction device for correcting the position of the receiving device with an offset in the direction of the orientation of the working direction and thus for determining the position of the vibration unit in the plane.

The vibration unit can be a so-called vibration bottle of an internal vibrator, having a housing in which an imbalance exciter and an electric motor driving the imbalance exciter are accommodated. As described above, the vibration unit may be connected to a protective and operating hose in order to allow an operator to move the vibration unit in the concrete to be compacted.

The surface position determination device is used to determine the position of or to locate the receiving device. The surface position determination device is thus able to determine the location of the receiving device in the surface or in the plane, that is to say at least two-dimensionally.

In one variant, the receiving device can also undertake transmission functions and in this respect serve as a transmitting/receiving device. In this way, for example, data collected during a concrete compaction process can be transmitted to external data networks, for example for documentation purposes.

The receiving device allows a position to be determined in the surface and can be carried, for example, on the operator. This is possible, for example, in a bracelet, on a belt, on a backpack, on a backpack carrying system, on a rechargeable battery that is used to supply power to the vibration unit, on a hand part held by the operator, on the protective and operating hose or directly on or in the vibration bottle. Since the surface position determination device serves to determine the position of the receiving device, it is useful to bring the receiving device close to the location of concrete compaction, that is to say close to the vibration unit.

A system with the highest possible accuracy should be used to determine the position. In particular, the accuracy must be higher than that of a conventional GPS system, the accuracy of which is usually not sufficient in the range of a few meters. Rather, the surface position determination device should use a positioning system that allows an accuracy below 1 m, in particular below 50 cm or below 20 cm.

The orientation determination device is intended to at least roughly capture the working or viewing direction of the operator, assuming that the operator is looking straight ahead in the direction of the vibration unit and does not turn his back. It can be assumed that the operator carries the receiving device in a suitable manner and looks in the direction of the vibration unit. As explained below, this orientation is intended to be used to specify the position detection of the vibration unit, in order to be able to draw conclusions about the exact location of the vibration unit from the precisely captured location of the receiving device.

The orientation determination device is thus used to determine the spatial orientation of the user. Suitable components can be used for this purpose, e.g. an electronic compass, a magnetometer, in particular with a plurality of degrees of freedom, or sensors for determining rotation rates and rotational accelerations.

The correction device is used to correct the position of the receiving device, as determined by the surface position determination device, by means of an offset, taking into account the orientation of the working direction determined by the orientation determination device. The offset represents a correction value in the direction of the orientation determined by the orientation determination device and thus the orientation of the operator. In this way, the offset is used to take into account the fact that the vibration unit in the plane is not directly arranged on the receiving device, but rather slightly removed. For example, the offset may approximately correspond to the arm length of an operator when the receiving device is carried on the operator. When the receiving device is carried in a backpack on the operator's back, the offset value may be slightly larger than the arm length in order to take into account the additional distance from the backpack.

Factoring in the offset and the orientation makes it possible to determine the position of the vibration unit in the plane/surface, i.e. two-dimensionally, with high accuracy. The position of the vibration unit in the plane means virtually “in plan view”, i.e. two-dimensional.

The receiving device of the surface position determination device may be designed such that it is carried by the operator. As already explained above, the receiving device can be arranged in a housing that the operator can carry or that is carried on the operator, e.g. by hand, on the belt, on the back, in a backpack, in a garment, etc.

The surface position determination device may have at least one positioning system selected from the group of RTK (Real Time Kinematic), DGPS (Differential Global Positioning System), UWB (Ultra-wide Band). Such positioning systems enable very high accuracy in the range of a few centimeters in the horizontal.

Bluetooth radio devices or optical systems, e.g. with image recognition, are also possible as positioning systems.

In order to increase the accuracy, it is also possible to combine a plurality of positioning systems and to use them to draw conclusions about the exact position of the receiving device.

The orientation determination device may have a device selected from the group of a north-seeking device, an electronic compass, a magnetometer, a rotational acceleration measurement device, a gyroscope, an inertial measurement unit (IMU).

Here too, it is possible to combine a plurality of devices in order to increase the accuracy when determining the orientation. For longer use or in combination with vibrations, rotational acceleration measurement devices or gyros are often subject to a slight drift which can be corrected well, for example, in combination with a compass. Other combinations may also be useful.

A depth position determination device may be provided for the purpose of determining the position of the vibration unit in terms of depth. The depth can be measured in particular in relation to the position of the receiving device, i.e. by measuring the distance to the receiving device, for example. In particular, the z coordinate of the distance can be determined in order to obtain a measure of the depth relative to the receiving device. Other measurement methods are also possible in order to determine the depth position of the vibration unit.

In this way, in addition to the two-dimensional position detection in the surface or plane (surface position) described above, a third dimension (depth position) can also be determined. This allows the position of the vibration unit to be determined three-dimensionally in order to detect the location of the vibration unit even in the case of deep concrete components, e.g. walls.

The determination of the depth can thus be combined with the measurement system of the surface position determination device. The distance between the vibration unit and the receiving device, that is to say, for example, the backpack carrying system in which e.g. the rechargeable battery can also be accommodated, or another position measurement apparatus, can be determined.

A transmitting device or a further transmitting/receiving device can be located on the vibration unit and can be used to measure the distance to the receiving device of the surface position determination device on the operator or on the backpack. The measurement of the distance can be determined, for example, by evaluating the signal strength of the signal exchanged between the two units. When the vibration unit is immersed deeper, the distance increases and so the signal strength decreases. This allows a conclusion to be drawn on the depth of immersion.

The depth position determination device may in particular have a distance measurement device for measuring a distance between the vibration unit and the receiving device of the surface position determination device. The distance measurement device can thus measure the short distance between the transmitting/receiving device on the vibration unit and the receiving device of the surface position determination device. This can be used to infer the depth or the third dimension in the direction of the z-axis.

The distance measurement device can thus determine the distance on the basis of an attenuation of a radio signal which is exchanged between the vibration unit and the receiving device of the surface position determination device. Depending on the embodiment, it is sufficient to provide, on the vibration unit, a transmitting device which emits a radio signal, the strength of which is measured and evaluated by the receiving device of the surface position determination device or another suitable receiver at the operator in order to draw conclusions about the distance. In one variant, the distance measurement or determination of the depth, in particular the depth of immersion into the concrete to be compacted, can also be carried out with the aid of barometric sensors.

A documentation apparatus may be provided for the purpose of documenting the three-dimensional position of the vibration unit on the basis of the surface position and the depth position of the vibration unit. This allows the three-dimensional position of the vibration unit to be documented over time. In particular, it is possible to record where and for how long the vibration unit has been present.

The documentation can therefore be effected not only in terms of time, but also with a three-dimensional, i.e. spatial, assignment. In this way, for example, three-dimensional heat maps can also be created for concrete components with a greater depth extension in order to record not only a compaction in the plane, but also in the depth. In this context, the degrees of compaction achieved at each of the compaction locations can also be documented.

For this purpose, the measured data can also be transmitted to a data transmission system, e.g. a cellphone or a gateway, in order to be collected and evaluated at a central location.

In addition, the data can be used by assistance systems, as explained below.

A system for guiding an operator during concrete compaction with a concrete compaction apparatus is specified, having a planning apparatus for storing planning data, wherein the planning data are used to define locations in a defined region at which concrete compaction with the concrete compaction apparatus has to be carried out; and having a position determination apparatus for determining the respective current position of the concrete compaction apparatus; and having a display device for displaying the respective location at which concrete compaction currently has to be carried out.

As an assistance system, the system can assist an operator during concrete compaction as part of a concreting process by giving the operator instructions as regards the location at which respective concrete compaction should currently be carried out in each case. The compaction locations may be in particular locations at which the concrete compaction apparatus is intended to be immersed in the concrete to be compacted.

In one variant, the operator can also be given an order of the locations of concrete compaction. In this case, the planning data can also serve to define an order of the locations in which concrete compaction has to be carried out, wherein the display device may be designed to display that respective location in the order of locations at which concrete compaction currently has to be carried out.

This makes it possible to define locations at which compaction is intended to be carried out, wherein at least one location at which compaction is intended to be carried out is displayed.

The operator can then adhere to the specified order of compaction locations during the concreting process. Specifying an order may have the advantage that path optimization can be associated with it, so that the concreting can be carried out in a time-optimized and cost-optimized manner. Alternatively, however, the operator can also deviate from this and choose his own compaction order.

For example, in one variant, the operator can see a type of map with locations at which compaction is intended to be carried out, but can process these locations according to his own selection and can thus arrive at the desired compaction target. If locations are omitted, this could be indicated as compaction defects, e.g. in a “heat map”. This allows the operator to identify which areas still need to be compacted.

Depending on the variant or operating mode of the operator, it is therefore possible for only one compaction location, a plurality of compaction locations (without a specified order) or a plurality of compaction locations (with a specified or suggested order) to be displayed in each case.

The position determination apparatus may correspond to the apparatus described above for determining the position of a vibration unit which can be guided by an operator.

The defined region relevant to the planning apparatus can be, for example, a (surface) area with concrete to be compacted, e.g. within a formwork. In particular, the defined region may be the concrete surface into which the concrete compaction apparatus is intended to be immersed. The concrete surface can be captured as a whole or divided into sub-areas which can each be understood as a defined region.

The respective immersion points for the vibration bottle of an internal vibrator can be understood as locations. In particular, the locations within a surface (e.g. the concrete surface) can be provided with coordinates of the optimal immersion points.

The order of locations corresponds to the order of immersion points at which the vibration bottle is intended to be immersed successively into the concrete to be compacted and the concrete is thus intended to be compacted.

The display device shows the operator the place at which he should currently perform concrete compaction. This is possible, for example, by means of appropriate instructions, e.g. that the operator should move the internal vibrator forward or to the side by a certain distance. The operator can follow these recommendations for action and thus easily immerse the internal vibrator into the concrete at the place specified by the planning apparatus. The operator can thus see on the display device where he is currently supposed to carry out compaction.

The display device may have a display on which the operator can see the location directly or via which he receives a corresponding instruction to reach the location. For example, the display device can be a smartphone, a tablet, a smartwatch or the like. It is also possible to use VR glasses (virtual reality) or AR glasses (augmented reality). It is also possible to use a head-up display.

The display device may be designed to display the position of the concrete compaction apparatus and/or to display at least that respective location in the order of locations at which concrete compaction has to be carried out next. The operator can thus see on the display device the extent to which the positions of the internal vibrator and the insertion location deviate from each other. By moving the internal vibrator, the operator can thus easily reduce the deviation and carry out compaction at the intended place. It is possible to display not only the currently planned immersion point, but also the next or the further immersion points. The operator thus also recognizes the meaningfulness of the planning data specified by the planning apparatus.

The display device may be designed to display the location, at which concrete compaction currently has to be carried out or has to be carried out next, in relation to the current position of the concrete compaction apparatus. The current position of the internal vibrator can be displayed in relation to the current and/or next compaction location.

A compaction coordinate specification apparatus may be provided for the purpose of generating planning data that can be stored in the planning apparatus. The compaction coordinate specification apparatus can be provided separately, e.g. in the form of a laptop or even remotely in a larger data network. It only needs to be connected to the planning apparatus as required in order to transmit the planning data generated (if necessary externally). In addition to the immersion or compaction locations, the planning data can also include information relating to the respective compaction duration or the desired degree of compaction. The compaction duration and degree of compaction parameters indicate that the concrete has been sufficiently compacted at the appropriate place.

The operator thus receives, via the display device, a recommendation for a suitable movement measure to reduce the deviation between the immersion position or compaction position on the one hand and the position of the concrete compaction apparatus (e.g. the vibration bottle). For example, the operator can relocate the internal vibrator or change the immersion point. The display device can be used to display advice, such as arrows, or route information relating to how the operator should move the internal vibrator.

An approach detection apparatus may be provided for the purpose of detecting a state in which the deviation is less than a specified deviation limit value and for the purpose of generating a confirmation signal. The deviation limit value defines a permissible deviation between the (theoretically) specified “ideal” immersion location and the actual immersion location at which the vibration bottle is immersed into the concrete to be compacted. If the deviation limit value is not reached, a confirmation signal can be generated for the operator indicating that the vibration bottle has been immersed in the correct position.

Apart from the data for defining the locations at which concrete compaction has to be carried out, the planning data may have further data selected from the group of: the compaction duration at the relevant location, the compaction intensity at the relevant location, the number of compaction vibrations at the relevant location. This allows a detailed definition of how much compaction is intended to be carried out at which location or at which immersion point. This can be particularly interesting if the concrete part to be compacted is very differently contoured, with the result that compaction has to be carried out to different extents and with different intensities at different locations.

The described position determination apparatus can advantageously be used in a concrete compaction apparatus. Accordingly, a concrete compaction apparatus is specified, having an internal vibrator, wherein the internal vibrator has: a vibration unit for generating a vibration for the concrete compaction, an operating unit, and a protective and operating hose connecting the vibration unit and the operating unit; and having the apparatus described above for determining the position of the vibration unit of the internal vibrator.

The operating unit can be a switch, e.g. in a switch housing, a frequency converter, a rechargeable battery or, for example, a rechargeable battery in a backpack carrying system.

An accordance with another aspect of the invention, a method is provided for determining the position of a vibration unit for concrete compaction which can be guided by an operator is specified. The method includes determining the position of a receiving device arranged on an operator in the plane, and determining an orientation of a working direction of the operator. The method additionally includes correcting the position of the receiving device with an offset in the direction of the orientation of the working direction and, thus, determining the position of a vibration unit in the plane, and determining the position of the vibration unit in terms of depth, starting from the position of the vibration unit in the plane or from the position of the receiving device in the plane.

### BRIEF DESCRIPTION OF THE DRAWINGS

These and other features and advantages of the invention are explained in more detail below using examples with the aid of the accompanying figures, in which:

FIG. 1 shows a schematic plan view of a position determination apparatus for determining the position of a vibration unit for concrete compaction which can be guided by an operator;

FIG. 2 shows a side view of the position determination apparatus from FIG. 1;

FIG. 3 shows a side view of the position determination apparatus from FIG. 1, but with an internal vibrator with a longer protective and operating hose;

FIG. 4 shows the integration of the position determination apparatus in an assistance system;

FIG. 5 shows a plan view of a surface to be concreted and a compaction process using the assistance system; and

FIG. 6 shows a display device of the assistance system.

### DETAILED DESCRIPTION

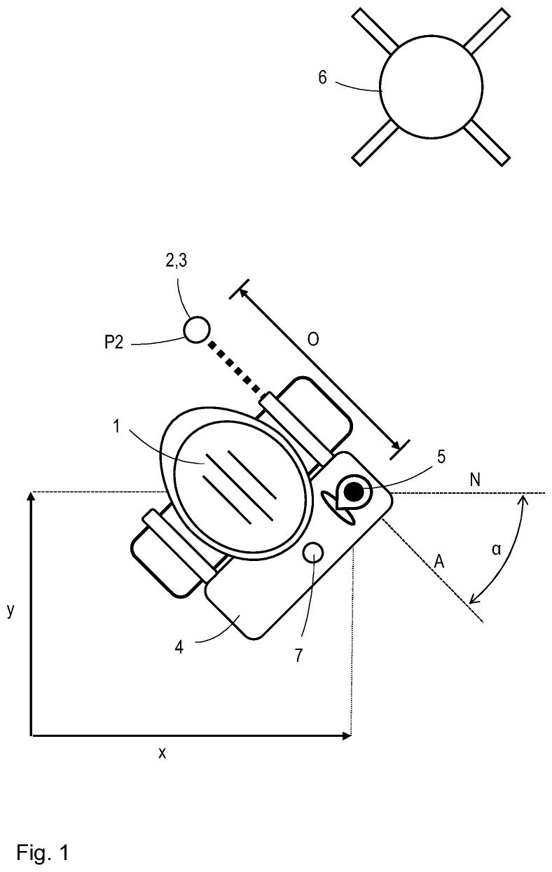

FIG. 1 shows a schematic plan view of an operator 1 (the protective helmet of the operator 1 is easily recognizable in the plan view) guiding an internal vibrator 2 for concrete compaction. Of the internal vibrator 2, only a vibration unit 3 is illustrated in FIG. 1, which vibration unit is often also referred to as a vibration bottle and contains an imbalance exciter, not illustrated, for generating the compaction vibrations and an electric motor for driving the imbalance exciter. The structure of such an internal vibrator 2 is known and therefore does not need to be expanded on further at this point.

The operator immerses the vibration unit 3 into the concrete to be compacted and holds it at one location for a certain period of time. Subsequently, the operator moves the vibration unit 3 to another location in order to continue compaction at another place.

In order to determine the compaction progress, various methods have been developed that indicate or communicate to the operator how far the compaction has progressed at the relevant place or whether sufficient compaction has been achieved (e.g. in the form of a degree of compaction). By way of example, reference is made to the post-published patent applications DE 10 2022 118 541 A1 and DE 10 2022 118 542 A1.

The internal vibrator 2 is equipped with a position determination apparatus by means of which the position of the vibration unit 3 can be determined with high accuracy in three-dimensional space, as will be explained later.

The electric motor located in the vibration unit 3 is fed by an electric energy store not illustrated or a rechargeable battery which is carried by the operator in a backpack 4 on his back. In addition to the rechargeable battery, other components can also be arranged in the backpack 4, e.g. a frequency converter which is not illustrated and can be used to adapt the electrical current obtained from the rechargeable battery in a manner suitable for the electric motor in the vibration unit 3. In particular, the direct current obtained from the rechargeable battery is converted into an alternating current or three-phase current and adapted in terms of the frequency.

Furthermore, a receiver 5 serving as a receiving device is arranged in the backpack 4. The receiver 5 is designed in such a way that its location can be determined with high or the highest possible accuracy. Appropriate positioning methods can be used for this purpose, e.g. the RTK (Real Time Kinematic), DGPS (Differential Global Positioning System) and/or UWB (Ultra-Wideband) method.

In the example shown in FIG. 1, the position measurement is carried out according to the RTK method with the aid of the receiver 5, which is designed as an RTK receiver, in conjunction with a fixed base station 6 which is arranged on the construction site near the working location.

Accuracies of 1 to 2 cm in the horizontal can be achieved in the RTK system. The coordinates of the points are calculated in real time after initialization. As with the DGPS system, the precise positions are determined relative to reference stations with fixed coordinates, e.g. the base station 6 here.

The positioning system together with the receiver 5 and—if available—the base station 6 form a surface position determination device.

The exact position of the receiver 5 can be determined, for example, by means of coordinates x, y with respect to the base station 6.

An orientation determination device 7 is also carried by the operator 1 with the aid of the backpack 4. The orientation determination device 7 can also be fitted at another location on the operator 1. It is used to determine the orientation of the operator 1 relative to a fixed coordinate system, e.g. relative to magnetic north. The orientation of the operator 1 can be used to directly infer his working direction.

In the example shown in FIG. 1, the measured orientation of the operator 1 is marked with A and differs from an absolute orientation, e.g. the north direction N, by the angle α. The working direction and the viewing direction of the operator 1 are also linked to the orientation A.

The orientation determination device 7 may have an electronic compass module or a magnetometer having a plurality of degrees of freedom in order to capture the spatial orientation A of the operator 1.

The position of the internal vibrator, in particular the vibration unit 3, can be calculated with high accuracy by means of the position of the operator 1 detected with the aid of the receiver 5 and the positioning system and the orientation A of the operator 1 captured by the orientation determination device 7. For this purpose, an offset O with the corresponding angle (e.g. α) is added to the position x, y which was measured for the location of the receiver 5 on the backpack 4. The offset O can take into account, for example, the arm length of the operator, wherein an oblique arm position can also be taken into account. In addition, the distance of the receiver 5 from the arm of the operator 1 can be taken into account, which receiver is located in the backpack 4 in the example shown in FIG. 1 and is thus behind the arm of the operator 1.

This makes it possible to determine the two-dimensional position P2 in the plane or surface and thus the two-dimensional position of the vibration unit 3 in the plan view shown in FIG. 1 with high accuracy.

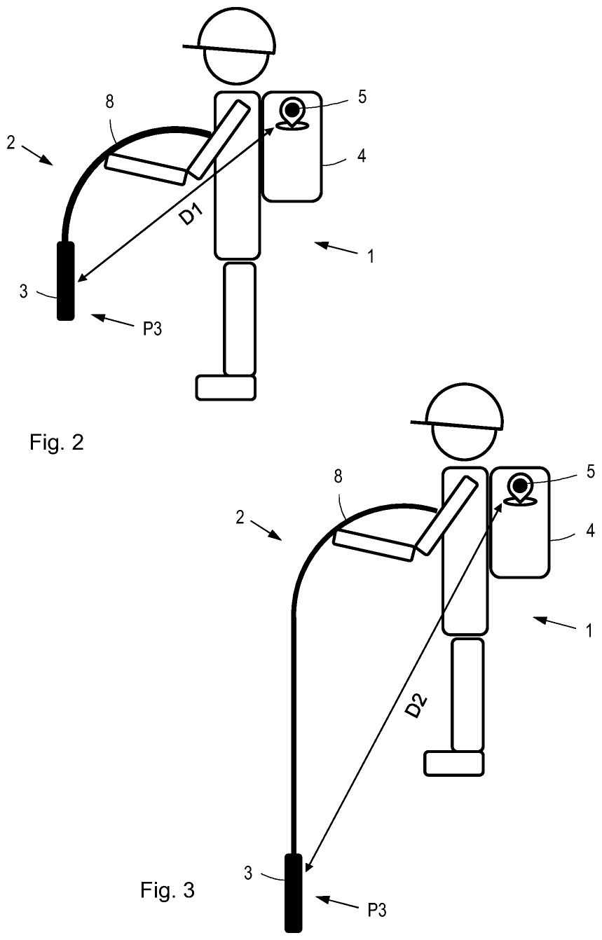

In addition, the depth is also detected in the position determination apparatus, with the result that the three-dimensional position of the vibration unit 3 can be determined. This is explained using FIGS. 2 and 3.

FIGS. 2 and 3 show the operator 1 in a schematic side view, each with the internal vibrator 2. The internal vibrator 2 has the vibration unit 3 which is held via a protective and operating hose 8. The protective and operating hose 8 connects the vibration unit 3 to the rechargeable battery in the backpack 4. Inside the protective and operating hose 8 are electrical lines which can be used to supply the electric motor in the vibration unit 3 with electric current. In addition, the protective and operating hose 8 is designed to be held by the operator 1 with his hands, as can be seen in FIGS. 2 and 3. The protective and operating hoses 8 have a different length in FIGS. 2 and 3.

In order to determine the position of the vibration unit 3 in terms of depth, the position determination apparatus has a further measurement system.

A depth position determination device is provided for the purpose of determining the position of the depth of the vibration unit 3. In particular, a depth coordinate with respect to the receiver 5 is measured. This can be achieved, for example, by determining the distance between the vibration unit 3 and the receiver 5. This distance is marked with D1 in FIG. 2, and with D2 in FIG. 3. The distance D1, D2 and the other coordinates and dimensions already explained above can be used to derive a depth coordinate in the z direction, which measures the relative height difference (depth) between the vibration unit 3 and the receiver 5.

The detection of the depth and thus the third dimension of the position of the vibration unit 3 allows the position to be captured three-dimensionally and thus with high accuracy, even in the case of deep concrete parts, e.g. walls.

For this purpose, the distance between the vibration unit 3 and the receiver 5 or a further transmitting/receiving apparatus is measured. The further transmitting/receiving device can be carried by the operator in a suitable manner and can also be accommodated, for example, in the backpack 4.

The determination of the distance between the internal vibrator and the receiver 5 or the further transmitting/receiving apparatus, not illustrated, can be measured by evaluating the signal strength of a radio signal exchanged between the components.

When the vibration unit 3 is immersed deeper into the concrete to be compacted, the distance D1, D2 increases, and so the signal strength decreases. This allows a conclusion to be drawn on the depth of immersion.

The position of the vibration unit 3 determined in this way can be sent, for example, to a mobile device or corresponding gateway and can be recorded thereby for the documentation of the concreting process.

The system makes it possible to fully document a concreting process and to assign the determined degrees of compaction not only generally locally in the surface, but also spatially. For documentation, it is possible to create so-called heat maps which can also be three-dimensional in the case of deeper components.

In addition, the precise detection of the respective location of the vibration unit 3 during the concreting process, in conjunction with the respective degree of compaction, constitutes a basis for assistance systems that can guide the operator 1. In particular, it is possible to indicate to the operator 1 the places at which the vibration unit 3 of the internal vibrator 2 must still be immersed in order to ensure complete compaction of poured concrete.

An example of such an assistance system is explained below.

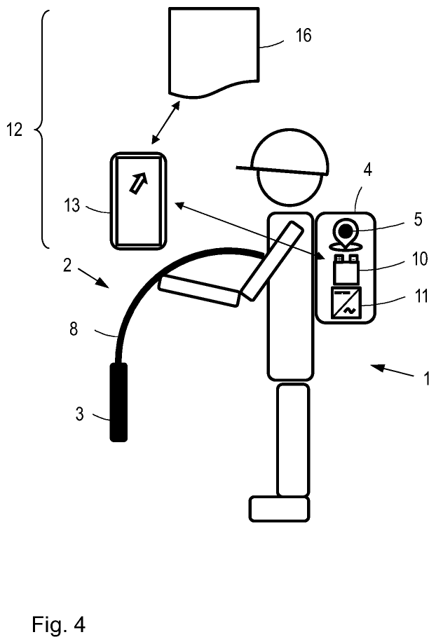

FIG. 4 shows the operator 1 with the internal vibrator 2. In addition, it is illustrated by way of example that, in addition to the receiver 5, a rechargeable battery 10 serving as an electrical energy store and a frequency converter 11 for supplying energy to the electric motor in the internal vibrator 2 are arranged in the backpack 4.

Furthermore, an assistance system 12 is provided for the purpose of guiding the operator 1 during concrete compaction. The assistance system 12 may have one or more components which are used in particular to plan the position and order of the compaction locations, to determine the current position of the vibration unit 3 and to display the respective current compaction location at which the operator 1 is intended to position the vibration unit 3.

Provided as part of the assistance system is a display 13, on which the operator 1 is shown where he is supposed to move the vibration unit 3 of the internal vibrator 2 in order to be able to position and immerse the vibration unit 3 at a place specified by the assistance system 12 (immersion location).

For this purpose, with the aid of the assistance system 12, it is possible to create planning data in advance relating to the locations of a concrete surface at which the still flowable concrete is intended to be compacted. At the same time, the order of the compaction locations can be specified.

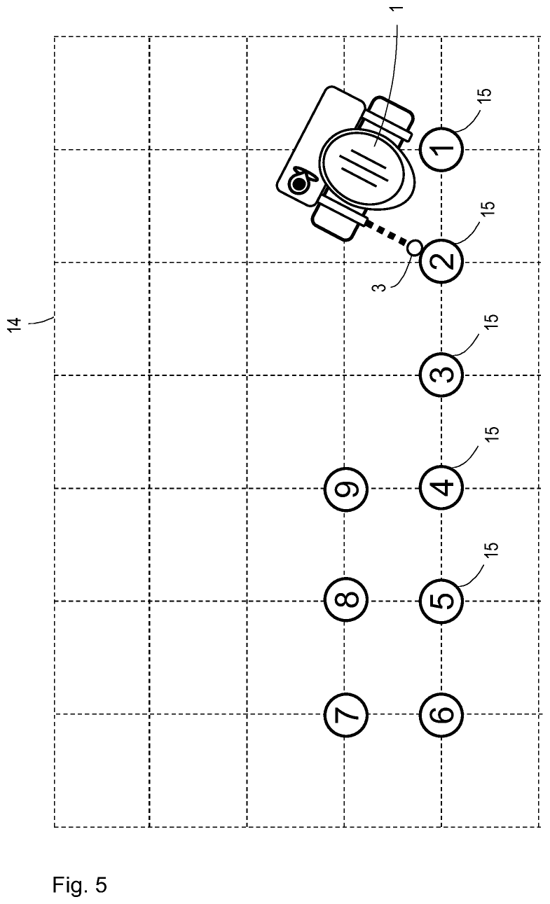

FIG. 5 shows a plan view of an example of the concreting of a surface, e.g. a hall floor.

The assistance system 12 stores a defined region 14 which can correspond to the total area of the hall floor to be concreted or only a partial area of the hall floor.

The defined region 14 is subdivided into compaction locations 15 at which compaction is intended to be carried out with the aid of the internal vibrator 2. In the example shown, the compaction locations 15 are numbered consecutively with 1, 2, 3, . . . , 9. The other areas of the defined region 14 can also be defined as compaction locations 15 in this way.

In the example shown in FIG. 5, the defined region 14 is divided by a grid structure and defined in the compaction locations 15. Of course, the compaction locations 15 can also be placed or sorted differently.

The defined region 14 and the compaction locations 15 can be specified externally, i.e. outside of the internal vibrator 2. In particular, this work can also be recorded via a network or with the aid of a laptop. The compaction locations 15 can be specified by an expert who has more in-depth knowledge of concrete compaction than the operator 1. The operator 1 thus only has to retrieve the compaction locations 15 one after the other.

For documenting the specification made by an expert or for automatically developing a suitable specification of the compaction locations 15 and their order, it is also possible to provide a compaction coordinate specification apparatus which forms a planning system that can be used to compile the planning data in advance.

For orientation, the operator 1 can be provided with appropriate information via the display 13 relating to where the next compaction location 15 can currently be found and where the operator 1 is intended to accordingly immerse the vibration unit 3.

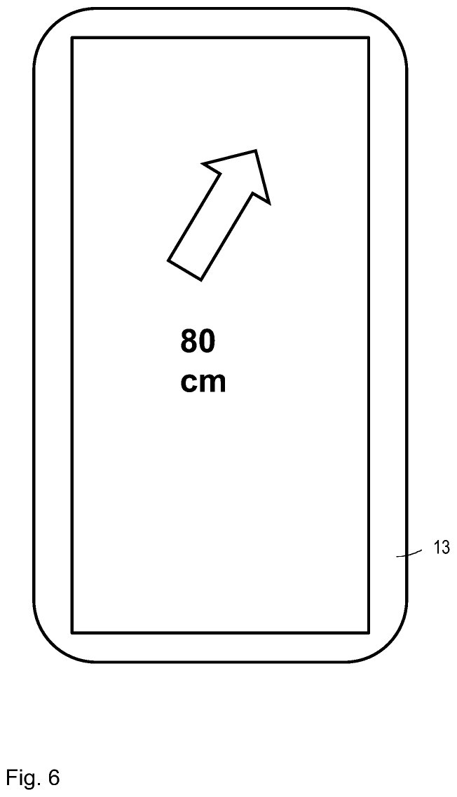

FIG. 6 shows, by way of example, a smartphone which serves as a display 13 and on which the operator 1 is shown, with the aid of an arrow and a distance indication (here: 80 cm), the direction in which and the extent to which he still has to move the vibration unit 3 before the vibration unit 3 has reached the specified position and can immerse in the concrete to be compacted.

The display 13 is only illustrated as an example. In particular, the display 13 does not need to be housed in a smartphone or tablet. In one variant, it is possible, for example, to integrate the display 13 in AR glasses (augmented reality) and in this way directly indicate to the operator the compaction locations 15 which he is intended to process successively. When visualizing the optimal compaction points using AR glasses, the compaction points can therefore be displayed directly to the operator on the concrete surface to be compacted.

In this respect, the compaction locations 15 can be understood as optimal compaction points which are specified by the planning system in advance.

In the working mode, the assistance system 12 resorts to the respective planning data and compares them with the current position of the operator 1 or the internal vibrator 2. The vibration unit 3 can be taken into account with particular accuracy.

If the operator 1 is in the optimum position or in sufficient proximity, he receives corresponding feedback, e.g. via the display 13, and can immerse the internal vibrator 2.

When the compaction process is completed, the operator 1 can receive feedback indicating that sufficient compaction has been carried out if the assistance system 12 is configured accordingly. This feedback can be given, for example, in a tactile manner, e.g. by a jerk in the protective and operating hose 8. Alternatively or additionally, acoustic and/or optical signals can also be generated, which indicate to the operator 1 that sufficient compaction has been carried out.

The direction and distance to the next compaction location 15 is then displayed to the operator 1 via the display 13.

During the concreting process, it is therefore possible to document on the display 13 whether sufficient compaction has been carried out at all planned points (compaction locations 15) or in a sufficient vicinity. If the display 13 is part of a mobile device, such as a smartphone or a tablet, the data can be sent to another network 16. However, the network 16 is not a mandatory component of the assistance system 12.

In one variant, it is possible for a certain period of time to begin to run when the operator has carried out compaction at one place. After a specified period of time has elapsed, it is indicated to the operator that the concrete is beginning to harden at this place and that compaction is no longer possible.

In another development, the operator can be requested to carry out compaction again at this place within this period of time if the compaction at this place was not sufficient. This allows the concrete to be compacted before it hardens.

1. An apparatus for determining the position of a vibration unit for concrete compaction which can be guided by an operator, the apparatus comprising:
a surface position determination device having a receiving device, wherein the surface position determination device is designed to determine a position of the receiving device in a plane;
an orientation determination device for determining an orientation (A) of a working direction of the operator; and
a correction device that is configured to correct the position of the receiving device with an offset (O) in the direction of the orientation (A) of the working direction and, thus, for determining a position (P2) of the vibration unit in the plane.

2. The apparatus as claimed in claim 1, wherein the receiving device of the surface position determination device is designed to be carried by the operator.

3. The apparatus as claimed in claim 1, wherein the surface position determination device has at least one positioning system selected from the group consisting of RTK (Real Time Kinematic), DGPS (Differential Global Positioning System), UWB (Ultra-wideband), Bluetooth radio devices, and optical systems with image recognition.

4. The apparatus as claimed in claim 1, wherein the orientation determination device has a device selected from the group consisting of a north-seeking device, an electronic compass, a magnetometer, a rotational acceleration measurement device, a gyroscope, and an inertial measurement unit (IMU).

5. The apparatus as claimed in claim 1, further comprising a depth position determination device that is configured to determine a position of the vibration unit in terms of depth.

6. The apparatus as claimed in claim 5, wherein the depth position determination device has a distance measurement device that is configured to measure a distance between the vibration unit and the receiving device of the surface position determination device.

7. The apparatus as claimed in claim 6, wherein the distance measurement device is configured to determine the distance on the basis of an attenuation of a radio signal which is exchanged between the vibration unit and the receiving device of the surface position determination device.

8. The apparatus as claimed in claim 5, wherein a documentation apparatus is provided for the purpose of documenting a three-dimensional position (P3) of the vibration unit on the basis of the surface position and the depth position of the vibration unit.

9. An assistance system for guiding an operator during concrete compaction with a concrete compaction apparatus having a vibration unit, the assistance system comprising:
a planning apparatus that is configured to store planning data, wherein the planning data are used to define locations in a defined region at which concrete compaction with the concrete compaction apparatus is to be carried out;
a position determination apparatus that is configured to determine a respective current position of the concrete compaction apparatus, the position determination apparatus including
a receiving device,
an orientation determination device for determining an orientation (A) of a working direction of an operator, and
a correction device that is configured to correct the position of the receiving device with an offset (O) in the direction of the orientation (A) of the working direction and, thus, for determining a position (P2) of the vibration unit in the plane; and
a display device for displaying at least the respective location at which concrete compaction currently is to be carried out.

10. The assistance system as claimed in claim 9, wherein the display device is designed to display the position of the concrete compaction apparatus and/or to display at least that respective location in the order of locations at which concrete compaction is to be carried out next.

11. The assistance system as claimed in claim 9, wherein the display device is designed to display the location at which concrete compaction currently is to be carried out or is to be carried out next, in relation to the current position of the concrete compaction apparatus.

12. The assistance system as claimed in claim 9, wherein a compaction coordinate specification apparatus is provided for the purpose of generating planning data that can be stored in the planning apparatus.

13. A concrete compaction apparatus comprising:
an internal vibrator, wherein the internal vibrator has:
a vibration unit for generating a vibration for concrete compaction;
an operating unit; and
a protective and operating hose connecting the vibration unit and the operating unit; and
a position determining apparatus that is configured to determine s position of the vibration unit of the internal vibrator, the position determining apparatus including
a receiving device,
an orientation determination device for determining an orientation (A) of a working direction of an operator and
a correction device that is configured to correct the position of the receiving device with an offset (O) in the direction of the orientation (A) of the working direction and, thus, for determining a position (P2) of the vibration unit in the plane.

14. A method for determining the position of a vibration unit for concrete compaction which can be guided by an operator, the method comprising:
determining a position of a receiving device arranged on an operator in the plane;
determining an orientation of a working direction of the operator;
correcting the position of the receiving device with an offset in a direction of the orientation of the working direction and, thus, determining the position of a vibration unit in the plane; and
determining a position of the vibration unit in terms of depth, starting from the position of the vibration unit in the plane or from the position of the receiving device in the plane.
